(19) United States
(12) Patent Application Publication
(10) Pub. No.: US 2013/0090936 A1
(43) Pub. Date: Apr. 11, 2013

(54) Configurable Visibility of Electric Vehicle Charging Stations

(71) Applicants: James Solomon, Saratoga, CA (US); Milton Tormey, Los Altos, CA (US)

(72) Inventors: James Solomon, Saratoga, CA (US); Milton Tormey, Los Altos, CA (US)

(21) Appl. No.: 13/646,728

(22) Filed: Oct. 7, 2012

Related U.S. Application Data
(60) Provisional application No. 61/545,086, filed on Oct. 7, 2011.

(51) Int. Cl. G06Q 50/06

(52) U.S. Cl. 705/1.1

(57) ABSTRACT

In one embodiment, an electric vehicle charging network server provides an interface for electric vehicle charging station owners to selectively configure whether their electric vehicle charging station(s) are displayable on a charging station locator application to a specific set of one or more electric vehicle operators. For example, the interface may allow an electric vehicle charging station owner to specify that one or more of its charging stations are capable of being displayed on a charging station locator application to only a group of one or more electric vehicle operators (those charging station(s) will not be displayed on a charging station locator application used by other electric vehicle operators).

### CROSS-REFERENCE TO RELATED APPLICATIONS

This application claims the benefit of U.S. Provisional Application No. 61/545,086, filed Oct. 7, 2011, which is hereby incorporated by reference.

### FIELD

Embodiments of the invention relate to the field of electric vehicle charging; and more specifically, to controlling visibility of electric vehicle charging stations on an electric vehicle charging locator application.

### BACKGROUND

Electric vehicle charging stations (hereinafter “charging stations”) are used to charge electric vehicles (e.g., electric battery powered vehicles, gasoline/electric battery powered vehicle hybrids, etc.). Charging stations may be located in designated charging locations (e.g., similar to a gas station), near parking spaces (e.g., public parking spaces and/or private parking space), at private residences, etc. Charging stations may be controlled (e.g., owned or leased) by governments, businesses, utilities, organizations, or other entities.

The location of electric vehicle charging stations may be displayed on a map available through the Internet. For example, users of electric vehicle charging service (e.g., drivers of electric vehicles) may search for electric vehicle charging stations in a given area (e.g., by city, zip code, etc.). The matching electric vehicle charging stations may be displayed on a map for that given area.

### SUMMARY

In one embodiment, an electric vehicle charging network server provides an interface for electric vehicle charging station owners to selectively configure whether their electric vehicle charging station(s) are displayable on a charging station locator application to a specific set of one or more electric vehicle operators. For example, the interface may allow an electric vehicle charging station owner to specify that one or more of its charging stations are capable of being displayed on a charging station locator application to only a group of one or more electric vehicle operators (those charging station(s) will not be displayed on a charging station locator application used by other electric vehicle operators).

### BRIEF DESCRIPTION OF THE DRAWINGS

The invention may best be understood by referring to the following description and accompanying drawings that are used to illustrate embodiments of the invention. In the drawings:

FIG. 1 illustrates a system for configurable charging station visibility according to one embodiment;

FIGS. 2A-B illustrate an exemplary charging station locator application according to one embodiment;

FIG. 3 is a flow diagram illustrating exemplary operations for configuring charging station visibility information according to one embodiment;

FIG. 4 is a flow diagram illustrating exemplary operations for locating charging stations through use of a charging station locator application according to one embodiment;

FIG. 5 illustrates an exemplary interface for configuring visibility ACLs according to one embodiment; and

FIG. 6 illustrates an exemplary interface for applying a visibility ACL to one or more charging stations according to one embodiment.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

In one embodiment, an electric vehicle charging network server receives charging station visibility configuration information from electric vehicle charging station owners to define the group of electric vehicle operator(s) that are allowed to view one or more of its electric vehicle charging stations through use of a charging station locator application. Thus, a particular electric vehicle operator may view only those charging stations that he or she is permitted to view.

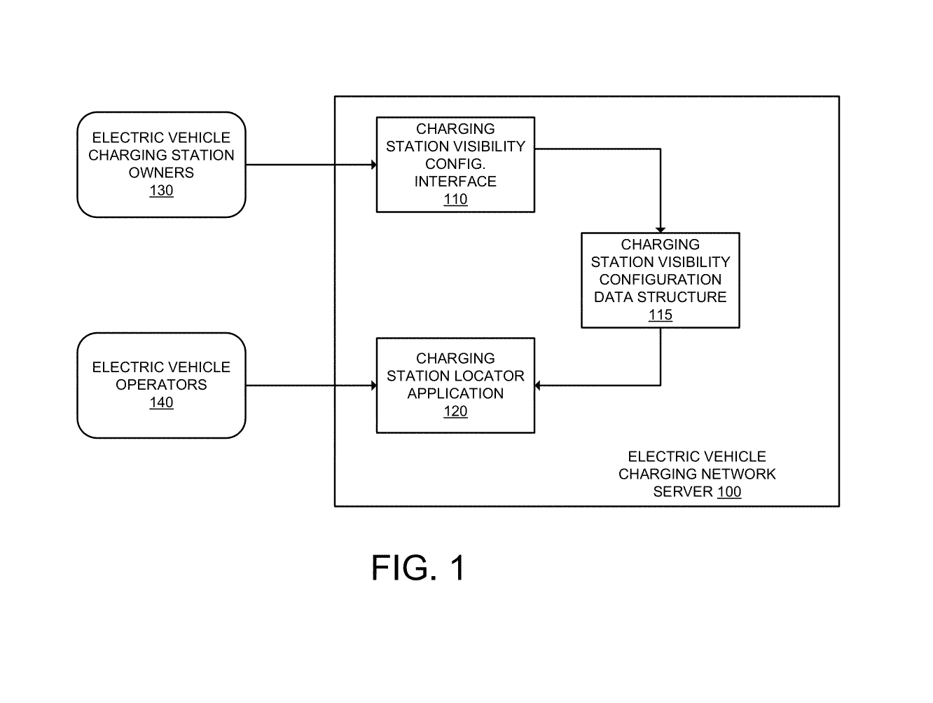

FIG. 1 illustrates a system for configurable charging station visibility according to one embodiment. The electric vehicle charging network server 100 allows electric vehicle charging station owners 130, which each own and/or operate one or more electric vehicle charging stations (“charging stations”), to selectively configure the visibility of one or more of their charging station on a charging station locator application to a group of one or more of the electric vehicle operators 140. For example, each owner 130 may use the charging station visibility configuration interface 110 to configure charging station visibility configuration data structure 115 for its charging station(s). The charging station visibility configuration interface 110 may be available through a web page, a mobile application, and/or an Application Programming Interface (API) embedded on web pages or mobile application.

The charging station visibility configuration data structure 115 indicates whether a particular electric vehicle operator is permitted to view a particular electric vehicle charging station. The charging station visibility configuration data structure 115 is used by a charging station locator application 120 to determine which charging stations (if any) to display to an electric vehicle operator 140.

The charging station locator application 120 allows the electric vehicle operators 140 to locate charging stations (e.g., in order to find the charging stations that are nearby and are currently available for use). For example, an electric vehicle operator may search for charging stations near a location, and may further restrict or refine the search based on availability (e.g., currently available, currently in use, currently unavailable), pricing, reservations, etc. The charging station locator application may be available through a web page, a mobile application, an API embedded on web pages or mobile application, an in-dash navigation system (via an API), the display of a charging station, and/or a display of a payment station coupled with a charging station.

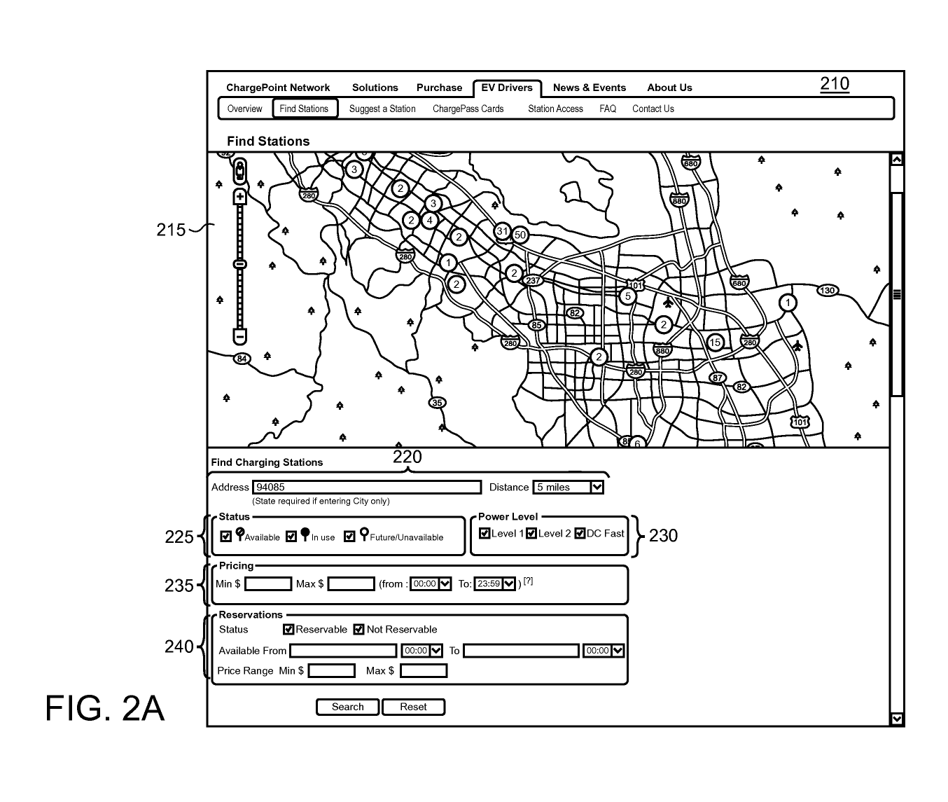

For example, FIGS. 2A-B illustrate an exemplary charging station locator application 210 according to one embodiment. The charging station locator application 210, which is available over the Internet, allows users to find charging stations based on a set of one or more station search parameters. Example station search parameters include charging station location 220 (e.g., city, state, zip code, etc.), charging station status 225 (e.g., currently available, currently in use, currently unavailable or a future station), the power level 230 of the charging stations (e.g., level 1 charging, level 2 charging, DC fast charging), the pricing 235 that is applicable to the charging stations (different charging stations may have different prices), and reservations 240 (an operator may search for charging stations that are not reserved for a certain time in the future). The results of the search are displayed in the interactive map 215 and/or the search results table 245 (illustrated in FIG. 2B).

In addition to meeting the station search parameters, the charging station locator application 210 displays to a particular electric vehicle operator only those charging stations that the electric vehicle operator is permitted to view. Thus, even if a charging station meets the station search parameters but the electric vehicle operator is not permitted to view that charging station, it will not be displayed on the charging station locator application 210.

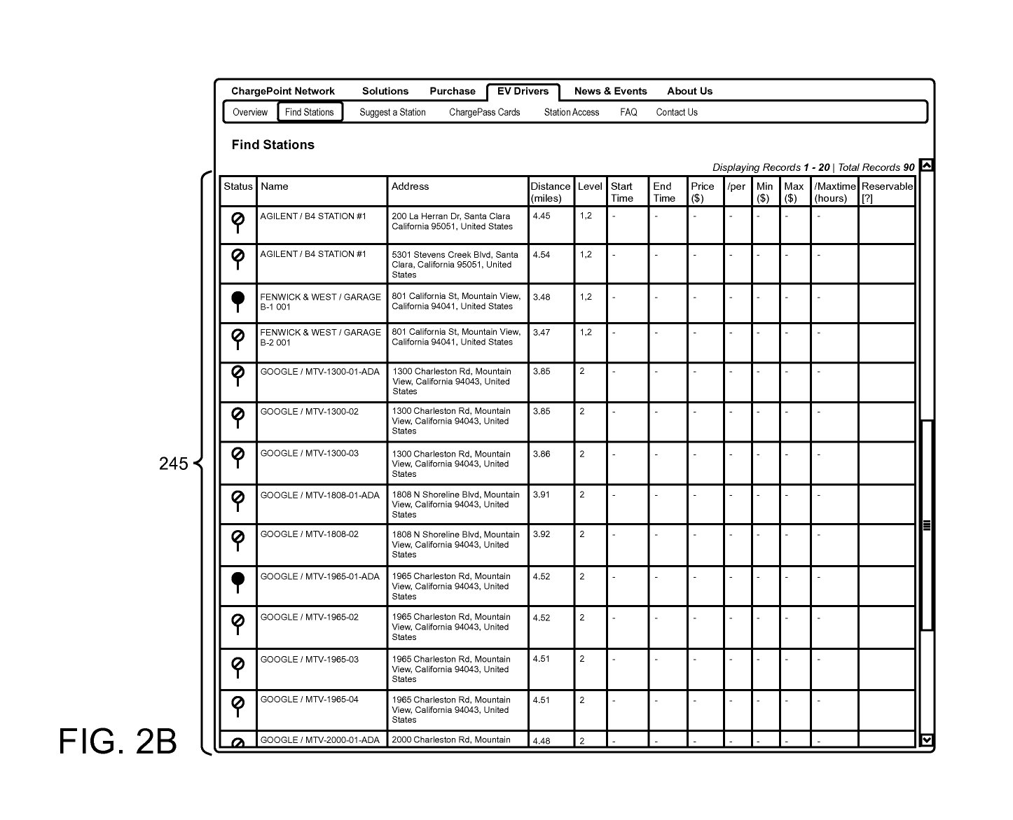

FIG. 3 is a flow diagram illustrating exemplary operations for configuring charging station visibility information according to one embodiment. The operations of FIG. 3 will be described with reference to the exemplary embodiment of FIG. 1. However, it should be understood that the operations of FIG. 3 can be performed by embodiments other than those discussed with reference to FIG. 1, and the embodiments discussed with reference to FIG. 1 can perform operations different than those discussed with reference to FIG. 3.

At operation 310, the electric vehicle charging network server 100 receives configuration information from an electric vehicle charging station owner 130 that defines a set of one or more electric vehicle operators that are permitted to view a set of one or more of its charging stations in the charging station locator application 120. By way of a specific example, a charging station owner 130 may use the charging station visibility configuration interface 110 to configure a visibility access control list (ACL) to include one or more identifiers that are associated with one or more electric vehicle operators (e.g., access card identifier(s), email address(es), electric vehicle charging service username(s), social networking site username(s), telephone number(s), credit card number(s), etc.). The charging station owner 130 may add specific identifiers and/or wildcard identifiers. The charging station owner 139 may then use the charging station visibility configuration interface 110 to apply the visibility ACL to one or more of its charging station(s).

The electric vehicle operator(s) that are associated with the identifier(s) on a visibility ACL that has been applied to a charging station will be permitted to view that charging station when using the charging station locator application 120. If an electric vehicle operator is not associated with an identifier on a visibility ACL that has been applied to a charging station, that operator will not be permitted to view that charging station when using the charging station locator application 120. Thus, after a visibility ACL has been applied to a charging station, only electric vehicle operators that are associated with an identifier that matches an identifier on the visibility ACL will be permitted to view that charging station when using the charging station locator application 120.

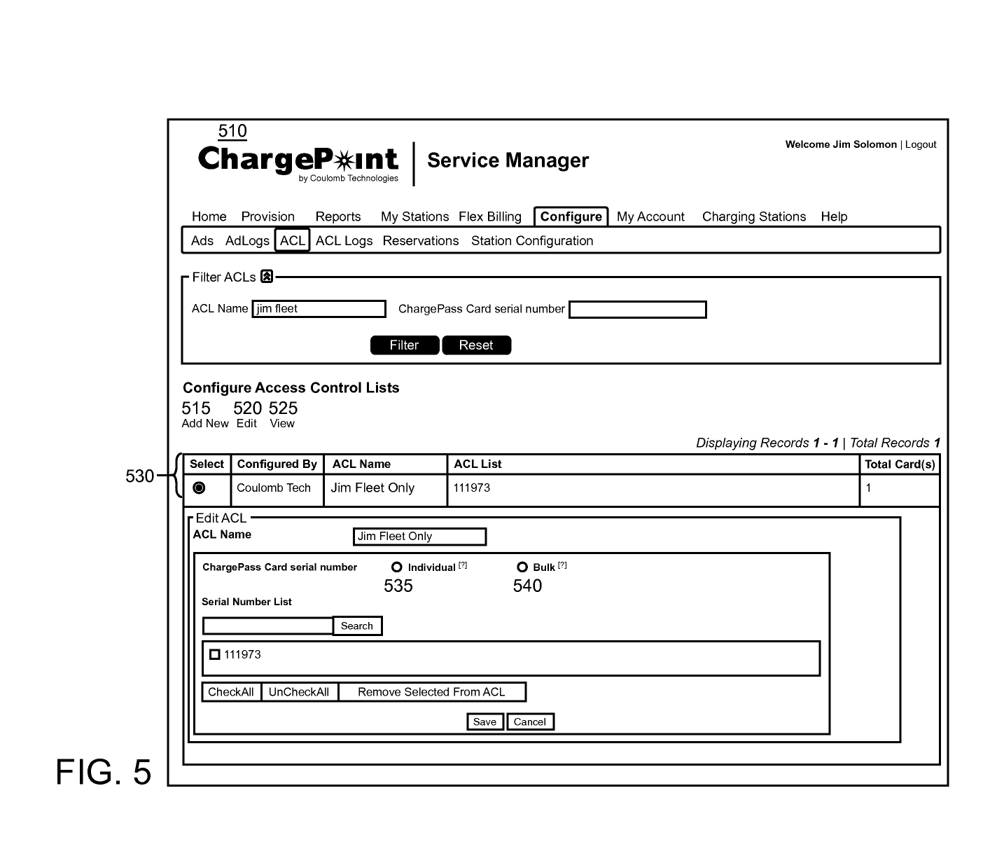

FIG. 5 illustrates an exemplary interface for configuring visibility ACLs according to one embodiment. The charging station visibility configuration interface 510, which is available over the Internet, allows charging station owners to configure visibility ACLs. For example, a charging station owner (once logged in) may add 515 a visibility ACL, edit 520 an existing visibility ACL, and/or view 525 an existing visibility ACL. The visibility ACL record portion 530 lists the visibility ACLs that have been configured by the charging station owner. The charging station owner can add identifiers either individually 535 or bulk (multiple) 540. For example, the charging station owner can list the identifiers (if selecting the individual option) and/or import a file of identifiers (e.g., a comma separated value file) (if selecting the bulk option). The charging station owner 130 may also add wildcard identifiers (e.g., 1234* would include all identifiers that begin with 1234).

While FIG. 5 illustrates that the charging station owner can add identifiers individually or in bulk to configure a visibility ACL, in other embodiments the visibility ACL may be configured differently. For example, in some embodiments, vehicle operators may be affiliated with a charging station owner (e.g., the vehicle operator may be a member of a charging service provided by the charging station owner, the charging station owner may invite the vehicle operator to be affiliated, etc.). In such embodiments, the charging station owner may configure a visibility ACL to include the affiliated vehicle operators

As another example, in some embodiments, vehicle operators may be classified as “home” vehicle operators for a group of charging stations and may be classified as “roaming” vehicle operators for another group of charging stations (the groups of charging stations may be owned by different charging station owners). In such embodiments, the charging station owner may configure a visibility ACL to include all of its “home” electric vehicle operators (and not include any “roaming” electric vehicle operators).

While FIG. 5 illustrates that the charging station owner can add an identifier (or a group of identifiers), in some embodiments the charging station owner can configure a visibility ACL by associating an account of an electric vehicle operator with a visibility ACL. An account of an electric vehicle operator may be associated with multiple identifiers (and may be associated with multiple individuals such as a case with a family plan). This provides a level of indirection such that if multiple identifiers are added to the an electric vehicle operator account or the identifiers change (e.g., if the operator loses an assigned RFID card), the visibility ACL does not need to be changed to reflect the changes.

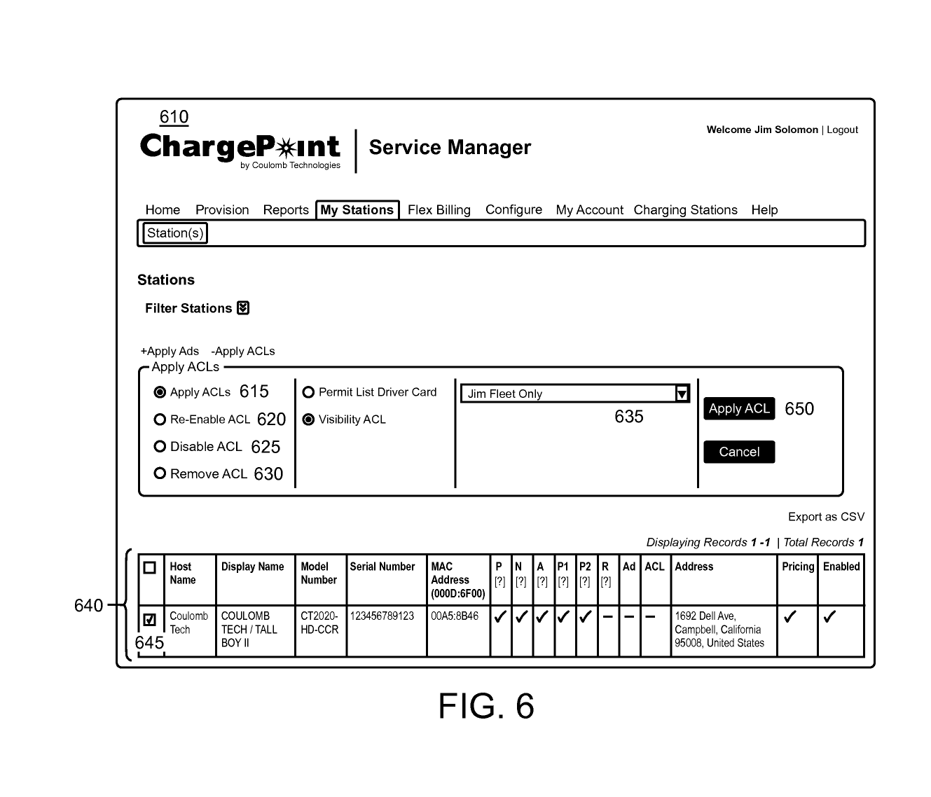

Sometime after configuring a visibility ACL with identifiers, the charging station owner can apply that visibility ACL to one or more charging stations. FIG. 6 illustrates an exemplary interface 610 for applying a visibility ACL to one or more charging stations according to one embodiment. The charging station owner can chose to apply a visibility ACL 615, re-enable a visibility ACL 620, disable a visibility ACL 625, and remove a visibility ACL 630. Assuming that the owner wants to apply a visibility ACL, the owner selects the visibility ACL 635 from the visibility ACLs previously created (as illustrated in FIG. 5). A list of the charging station owner's charging stations is displayed in the charging station area 640. Each charging station record displays parameters regarding that charging station (e.g., host name, display name, model number, serial number, MAC address, the current status of each port, the name of any advertisement or ACL (including visibility ACLs) that have been assigned to it, and the physical location. The selection button 645 allows the owner to select the charging station(s) that the visibility ACL will be applied to. Although FIG. 6 illustrates a single charging station being listed in the area 640 (meaning that this exemplary charging station owner has a single charging station), it should be understood that many charging stations may be listed in the area 640. After selecting the charging stations to apply the visibility ACL to, the owner selects the apply ACL button 650 to apply that visibility ACL.

Referring back to FIG. 3, flow moves from operation 310 to operation 315 where the electric vehicle charging network server 100 stores the visibility configuration information in the charging station visibility configuration data structure 115, which will be used by the charging station locator application 120.

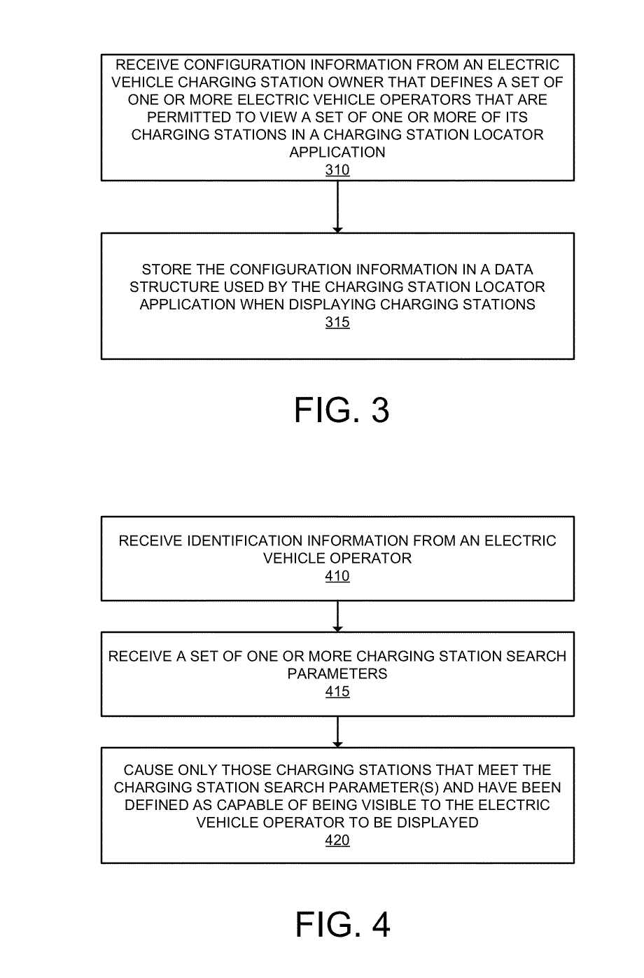

FIG. 4 is a flow diagram illustrating exemplary operations for locating charging stations through use of a charging station locator application according to one embodiment. The operations of FIG. 4 will be described with reference to the exemplary embodiment of FIG. 1. However, it should be understood that the operations of FIG. 4 can be performed by embodiments other than those discussed with reference to FIG. 1, and the embodiments discussed with reference to FIG. 1 can perform operations different than those discussed with reference to FIG. 4.

At operation 410, the electric vehicle charging network server 100 receives identification information from an electric vehicle operator 140. For example, the electric vehicle charging network server 100 receives login information from the electric vehicle operator 140. Next, flow moves to operation 415, where the network server 100 receives a set of one or more charging station search parameters from the electric vehicle operator 140. For example, the charging station locator application 120 receives charging station search parameters (e.g., charging station location (e.g., city, state, zip code, etc.), charging station status (e.g., currently available, currently in use, currently unavailable or a future station), the power level of the charging stations (e.g., level 1 charging, level 2 charging, DC fast charging), the pricing that is applicable to the charging stations (different charging stations may have different prices), and reservations. By way of a specific example, the electric vehicle operator 140 inputs the search parameters using the charging station locator application 210 described with reference to FIG. 2. Flow then moves to operation 420.

At operation 420, the electric vehicle charging network server 100 causes only those charging stations that meet the charging station search parameter(s) and have been defined as capable of being visible to the electric vehicle operator to be displayed through the charging station locator application. For example, in addition to determining the charging stations that meet the charging station search parameter(s), the charging station locator application 210 accesses the charging station visibility configuration data structure 115 to determine the charging stations (if any) that should be displayed to the electric vehicle operator. By way of a specific example, the charging station locator application 210 determines those charging stations (if any) in which there is a visibility ACL that has been applied that includes or matches an identifier associated with the electric vehicle operator.

Thus, electric vehicle charging station owners may configure their charging station(s) to be visible to certain electric vehicle operators using a charging station locator application instead of being generally viewable.

While FIG. 1 illustrates the functionality for configuring charging station visibility and the charging station locator application residing on the same electric vehicle charging network server, it should be understood that this functionality may be on separate devices.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., servers, client devices). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory computer-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in an electric vehicle charging network server for configuring charging station visibility, comprising:
receiving configuration information from an electric vehicle charging station owner that owns or operates a set of one or more electric vehicle charging stations, wherein the received configuration information indicates a set of one or more electric vehicle operators that are permitted to view one or more of the set of electric vehicle charging stations; and
storing the received configuration information to be used by an electric vehicle charging station locator application.

2. The method of claim 1, further comprising:
receiving identification information from an electric vehicle operator;
receiving a set of one or more charging station search parameters via the electric vehicle charging station locator application;
determining that the electric vehicle operator is permitted to view the set of electric vehicle charging stations; and
displaying, via the electric vehicle charging station locator application, only those of the set of electric vehicle charging stations that the meet the set of charging station search parameters.

3. The method of claim 1, wherein the received configuration information is received through one of a web page, a mobile application, and an Application Programming Interface (API).

4. The method of claim 1, wherein the received configuration information configures one or more identifiers are that are associated with one or more electric vehicle operators on a visibility access list.

5. The method of claim 1, wherein the electric vehicle charging station locator application allows electric vehicle operators to locate charging stations.

6. The method of claim 1, wherein only the set of electric vehicle operators are permitted to view the one or more electric vehicle charging stations via the electric vehicle charging station locator application.

7. A method in an electric vehicle charging network server for locating charging stations, comprising:
receiving identification information from an electric vehicle operator;
receiving a set of one or more charging station search parameters; and
causing only those charging stations that meet the set of charging station search parameters and have been defined as capable of being visible to the electric vehicle operator to be displayed to the electric vehicle operator.

8. The method of claim 7, wherein the step of causing includes accessing a data structure that stores information that defines one or more identifiers associated with one or more electric vehicle operators that are permitted to view one or more electric vehicle charging stations.

9. The method of claim 7, wherein the set of charging station search parameters includes one or more of charging station location, charging station status, power level of charging station, pricing, and reservations.

10. The method of claim 7, wherein the received charging station search parameters are received via an electric vehicle charging station locator application; and wherein those charging stations that meet the set of charging station search parameters and have been defined as capable of being visible to the electric vehicle operator are displayed to the electric vehicle operator via the electric vehicle charging station locator application.

11. The method of claim 10, wherein the electric vehicle charging station locator application is available through one of a web page, a mobile application, an in-dash navigation system, a display of a charging station, and a display of a payment station coupled with a charging station.

12. A non-transitory computer-readable storage medium that provides instructions that, if executed by a processor, will cause said processor to perform operations comprising:
receiving configuration information from an electric vehicle charging station owner that owns or operates a set of one or more electric vehicle charging stations, wherein the received configuration information indicates a set of one or more electric vehicle operators that are permitted to view one or more of the set of electric vehicle charging stations; and
storing the received configuration information to be used by an electric vehicle charging station locator application.

13. The non-transitory computer-readable storage medium of claim 12, wherein the medium further provides instructions that, if executed by the processor, will cause said processor to perform operations comprising:
receiving identification information from an electric vehicle operator;
receiving a set of one or more charging station search parameters via the electric vehicle charging station locator application;
determining that the electric vehicle operator is permitted to view the set of electric vehicle charging stations; and
displaying, via the electric vehicle charging station locator application, only those of the set of electric vehicle charging stations that the meet the set of charging station search parameters.

14. The non-transitory computer-readable storage medium of claim 12, wherein the received configuration information is received through one of a web page, a mobile application, and an Application Programming Interface (API).

15. The non-transitory computer-readable storage medium of claim 12, wherein the received configuration information configures one or more identifiers are that are associated with one or more electric vehicle operators on a visibility access list.

16. The non-transitory computer-readable storage medium of claim 12, wherein the electric vehicle charging station locator application allows electric vehicle operators to locate charging stations.

17. The non-transitory computer-readable storage medium of claim 12, wherein only the set of electric vehicle operators are permitted to view the one or more electric vehicle charging stations via the electric vehicle charging station locator application.

18. A non-transitory computer-readable storage medium that provides instructions that, if executed by a processor, will cause said processor to perform operations comprising:
receiving identification information from an electric vehicle operator;
receiving a set of one or more charging station search parameters; and
causing only those charging stations that meet the set of charging station search parameters and have been defined as capable of being visible to the electric vehicle operator to be displayed to the electric vehicle operator.

19. The non-transitory computer-readable storage medium of claim 18, wherein the step of causing includes accessing a data structure that stores information that defines one or more identifiers associated with one or more electric vehicle operators that are permitted to view one or more electric vehicle charging stations.

20. The non-transitory computer-readable storage medium of claim 18, wherein the set of charging station search parameters includes one or more of charging station location, charging station status, power level of charging station, pricing, and reservations.

21. The non-transitory computer-readable storage medium of claim 18, wherein the received charging station search parameters are received via an electric vehicle charging station locator application; and wherein those charging stations that meet the set of charging station search parameters and have been defined as capable of being visible to the electric vehicle operator are displayed to the electric vehicle operator via the electric vehicle charging station locator application.

22. The non-transitory computer-readable storage medium of claim 21, wherein the electric vehicle charging station locator application is available through one of a web page, a mobile application, an in-dash navigation system, a display of a charging station, and a display of a payment station coupled with a charging station.
